(19) United States
(12) Patent Application Publication
(10) Pub. No.: US 2015/0310383 A1
(43) Pub. Date: Oct. 29, 2015

(54) Inventory and Supply Chain Control and Tracking Methods and Systems

(71) Applicants: Alexander Robb Iser, Broken Arrow, OK (US); Aaron Lee Bedingfield, Tulsa, OK (US); Jesse Ray Wells, Tulsa, OK (US)

(72) Inventors: Alexander Robb Iser, Broken Arrow, OK (US); Aaron Lee Bedingfield, Tulsa, OK (US); Jesse Ray Wells, Tulsa, OK (US)

(21) Appl. No.: 14/262,931

(22) Filed: Apr. 28, 2014

(51) Int. Cl. G06Q 10/08; G06Q 30/06

(52) U.S. Cl. CPC G06Q 10/087; G06Q 30/0635

(57) ABSTRACT

Inventory and supply chain control and tracking methods and systems are described herein. A method may include maintaining a database of compound identifiers that represent products and providers. A compound identifier includes a product identifier that identifies a product and a provider identifier that is appended to the product identifier, the provider identifier identifying a party that manufactures, distributes, provides, or sells the product to a reseller.

### FIELD OF THE INVENTION

The present technology is directed generally to inventory and supplier control, and more specifically, but not by way of limitation, to systems, databases, and methods of inventory and supplier control using hybrid or compound identifiers that allow products to be easily tracked, as well as efficiently identified with respect to key aspects, attributes of products, or providers associated with the products.

### SUMMARY OF THE PRESENT TECHNOLOGY

According to some embodiments, the present technology may be directed to a method of inventory and supply chain management executed by an inventory management system. The method includes: (a) receiving a request for a product from a first party; (b) querying a database of compound identifiers that represent products and providers, wherein a compound identifier comprises a product identifier that identifies a product and a provider identifier that is appended to the product identifier, the provider identifier identifying a second party that manufactures, distributes, or sells the product; (c) transmitting one or more matching products to the first party; (d) receiving a selection of a product of the one or more matching products; and (e) storing a sales order for the product in a database.

According to some embodiments, the present technology is directed to a method of inventory and supply chain management executed by an inventory management system. The method includes maintaining a database of compound identifiers that represent products and providers, wherein a compound identifier comprises a product identifier that identifies a product and a provider identifier that is appended to the product identifier, the provider identifier identifying a party that manufactures, distributes, or sells the product.

According to some embodiments, the present technology is directed to an inventory and supplier control system that includes: (a) means for querying a database of compound identifiers that represent products and providers, wherein a compound identifier comprises a product identifier that identifies a product and a provider identifier that is appended to the product identifier, the provider identifier identifying a second party that manufactures, distributes, or sells the product; and (b) means for: (i) transmitting one or more matching products to the first party; (ii) receiving a selection of a product of the one or more matching products; and (iii) means for transmitting an order to the second party associated with the selection, as identified by the provider identifier of the compound identifier for the selected product.

According to some embodiments, the present technology is directed to a database, comprising compound identifiers that represent products, wherein a compound identifier comprises a product identifier that identifies a product and a provider identifier that is appended to the product identifier, the provider identifier identifying a second party that manufactures, distributes, or sells the product.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is an embodiment of a computing architecture that is used to practice aspects of the present technology;

FIG. 2 is a flowchart of an example method for generating a compound identifier and storing the same in a database;

FIG. 3 is a flowchart of a method for creating an extended compound identifier;

FIG. 4 is a flowchart of an example method for locating a product in a database using a compound identifier and processing an order;

FIG. 5 is a flowchart of an example method for tracking an order using a compound identifier for the product included in the order;

FIG. 6 is a flowchart of an example method for facilitating the return of a product using an RMA process, the process using a compound identifier;

FIG. 7 is a schematic diagram of another computing architecture that can be used to practice aspects of the present technology; and

FIG. 8 illustrates an exemplary computing device that is used to implement embodiments according to the present technology.

### DESCRIPTION OF EXEMPLARY EMBODIMENTS

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

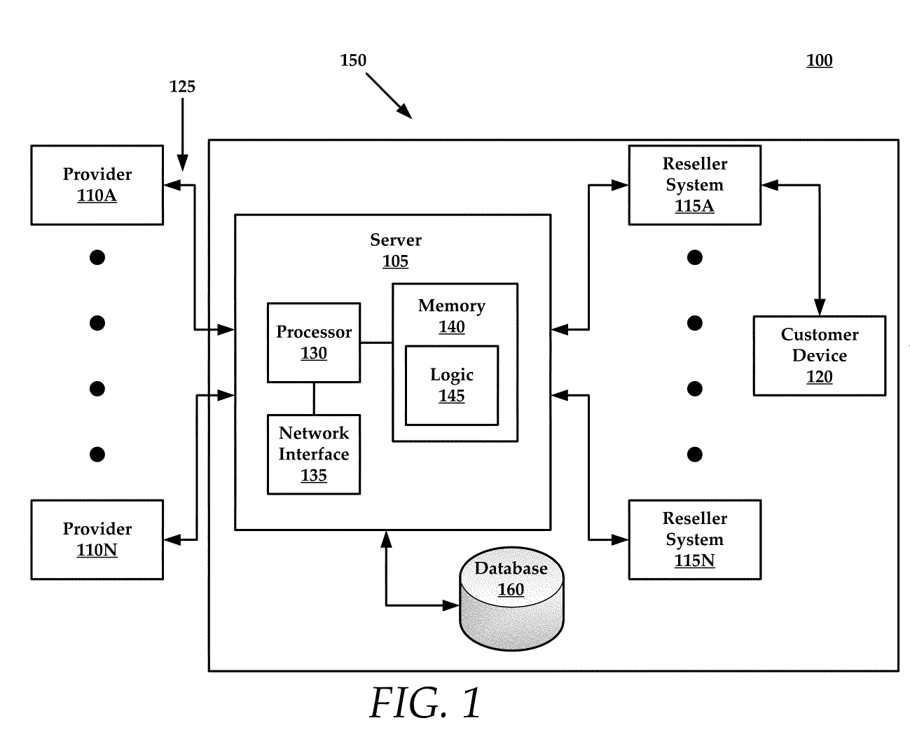

FIG. 1 illustrates an exemplary architecture 100 for practicing aspects of the present technology. The architecture 100 comprises in inventory and supply chain system, hereinafter “server 105” that is configured to provide various inventory control and supply chain tracking and management functionalities, which will be described in greater detail infra.

Generally the server 105 is configured to communicate with external systems, such as provider systems 110A-N, as well as reseller systems 115A-N. It will be understood that the provider and reseller systems that are described in various embodiments herein are merely an example description of roles that can be attributed to entities that can be configured to use the inventory and supply chain features provided by the server 105. The methods and system described herein can likewise be applied to other industries having other typical participating parties that utilize an inventory control systems.

Broadly, the architecture 100 of FIG. 1 illustrates an embodiment of the present technology that allows for a software-as-a-service (“SaaS”) implementation where the server 105 provides the functionalities of the present technology. These features are made accessible to external devices, such as the provider and reseller systems illustrated. Thus, rather than requiring these external devices to store, execute, and perform the methods directly these external systems may access the inventory control applications of the present technology through the server 105, using for example, web-based interfaces.

It will be understood that the functionalities described herein, which are attributed to the server 105 may also be executed within the external systems themselves. For example, a reseller system 115A may be programmed to execute the functionalities described herein. In other instances, the server 105 and reseller system 115A (or any other combination of systems included in FIG. 1) may cooperate to provide the functionalities described herein, such that the reseller system 115A is provided with a client-side application that interacts with the server 105 such that the server 105 and reseller system 115A operate in a client/server relationship. Complex computational features may be executed by the server 105, while simple operations that require fewer computational resources may be executed by the reseller system 115A, such as data gathering and data display.

In the examples provided herein, for purposes of brevity and context, the provider systems 110A-N are each associated with entities (e.g., second party) that manufacture, produce, and/or distribute parts for electronic devices. Again, the provider provides products to a reseller. Likewise, the reseller systems 115A-N are each associated with entities that convey these parts to customers. The conveyance of parts may include direct sales or incorporation of parts into customer devices, just as examples.

For example, reseller 115A may sell a replacement battery produced by provider 110N, for customer device 120. In some instances, a provider may be referred to as a “second party”, while a reseller may be referred to as a “first party”.

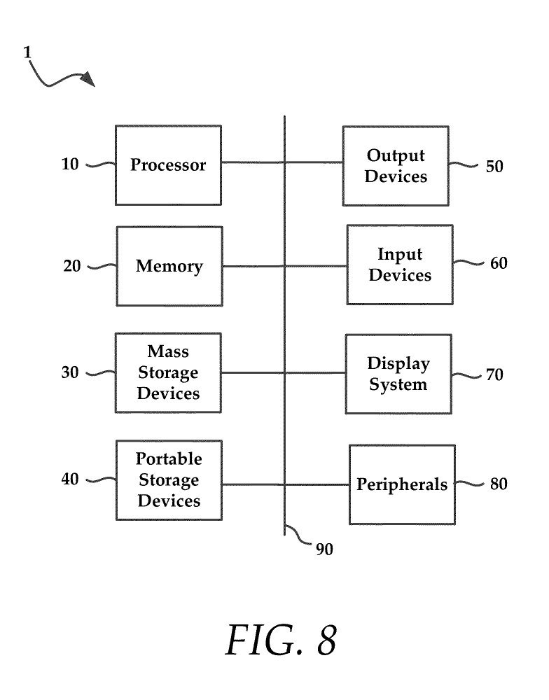

The computing device used by product manufacturers and resellers may include, for example, a Smartphone, a laptop, a computer, or other similar computing device. An example of a computing device that can be utilized in accordance with the present invention is described in greater detail with respect to FIG. 8. Additionally, general aspects of computing such as data transmission, data storage, data display, and so forth with respect to server 105 are likewise described with respect to the computing device of FIG. 8.

The server 105 may communicatively couple with both the provider systems 110A-N and reseller systems 115A-N via a public or private network, such as network 125, illustrated here only as a network connection linking provider system 110A and server 105. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 125 can further include or interface with any one or more of an RS-232 serial connection, an IEEE-1394 (FireWire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The server 105 generally comprises a processor, 130, a network interface 135, and a memory 140. According to some embodiments, the memory 140 comprises logic (e.g., instructions or applications) 145 that can be executed by the processor 130 to perform various methods, such as a method for inventory and supply chain management. The server 105 may use the network interface to couple with the network 125.

Prior to describing these methods, a more detailed description of the entities and their roles will be provided. Again, these descriptions are merely examples of a business sector (e.g., sale of electronic devices and components) that includes entities (e.g., manufacturers and resellers) who can utilize the methods. These descriptions are non-limiting and can be applied to a wide variety of other industries and their participating entities.

In general, provider systems 110A-N may each manufacture, produce, distribute, and/or provide one or more components for an electronic device. For example, provider system 110A produces a battery and processor for customer device 120. Additionally, provider system 110N produces touchscreens that can be used with customer device 120. It will be appreciated that a customer device may be comprised of hundreds or thousands of parts, each of which may be produced by a different manufacturer. Thus, to ensure that the reseller can service customers with many different types of devices, the reseller typically has a broad and diverse inventory of products on hand to service their customers.

Thus, a reseller, such as reseller 115A obtains many types of products from many types of providers. For example, reseller 115A may include a cellphone repair facility that sells components and accessories for the customer device 120, which in this example includes a cell phone. In some instances, a plurality of reseller systems, such as reseller systems 115A-N may be associated with a particular company that has a plurality repair or service locations. Products within inventory for each of the resellers may be stored in a warehouse or other location, while often ordered or needed products may be kept on site at individual reseller locations.

In some instances, each of the reseller systems 115A-N is located at a different physical location. For example, a plurality of reseller systems 115A-N may be distributed over a city or a state, each servicing customers in a particular geographical location. In these instances, the server 105 may be a part of a reseller network 150. Thus, each of the reseller systems 115A-N may network with the server 105 and the server acts as central inventory system.

Broadly, the present technology is configured to track products using compound identifiers that can identify not only the product, but also the product provider. Thus, sellers or resellers of the products can quickly and easily identify a provider that produced a particular product in a quick and efficient manner. Due to the overwhelming number of products offered by a reseller, the compound identifiers and databases of the present technology provide a cohesive method of tracking in-service dates, warranty periods, product returns, and so forth, using these compound identifiers. Additional details regarding these compound identifiers and methods of use are provided herein.

Prior to serving customers, an inventory database, such as database 160 is created with compound identifiers for products stored in the database 160. Generally, the database 160 includes various records that reference and utilize compound identifiers that represent products. Broadly described, a compound identifier comprises a product identifier that identifies a product and a provider identifier that is appended to the product identifier. The provider identifier identifies a second party that manufactures, distributes, provides, and/or sells the product. In some instances the second party provides the product to a reseller, who in turn conveys the product to a customer. The compound identifier is an efficient unit that can be used to track the relationship between the provider, reseller, and customer for purposes such as returns, warranties, and other similar purposes.

In some instances, the database 160 may store only compound identifiers for products and other records that reference or use these compound identifiers are stored in other storage media.

As mentioned above, a compound identifier is a representation that may include descriptive information for a product. In some instances, a compound identifier includes a product identifier that identifies a product and a provider identifier that is appended to the product identifier. The product identifier is descriptive of the attributes of the product. For example, a product identifier may be created for touchscreen component that can be used in various devices. In one embodiment, the product identifier is a nine character unit that is comprised of alpha-numeric characters, although non-standard characters such as “&”, “@”, and “$” can also be utilized. Other amounts of characters, fewer or more than nine, can also likewise be utilized. As will be discussed in greater detail below, the product identifier can be logically segmented and built to identify various attributes of a product. The product identifier can be randomly generated in some instances.

The compound identifier may also include a provider identifier that identifies a second party that manufactures, distributes, provides, and/or sells the product. For example, the provider identifier is a three character set that references provider system 110A, such as “AP1”, while provider system 110N is “SM2”. The server 105 may generate and assign a provider identifier to each provider as providers register with the server 105. As with the product identifier, the provider identifier may include fewer or more digits than those described and can include both standard alpha numeric characters and/or non-standard characters.

A provider can apply the compound identifier to each product that they offer to the resellers. In other instances, the provider is not privy to the compound identifier at all. The provider may transmit a provider SKU that can be linked to a compound identifier for the same product. The server 105 may create and maintain this linkage. Methods for matching and linking provider SKUs and compound identifiers can be found in greater detail herein.

The compound identifier can be embodied as indicia that are printed on a label, but may also be embodied or incorporated into a barcode, a quick response (QR) code, an image, a watermark, or other embodiment as would be known to one of ordinary skill in the art with the present disclosure before them.

By way of example, compound identifiers “234NG321H-AP1”; “432JF342R-AP1”; and “958IO692T-AP1”, would indicate three different products as identified by product identifiers 234NG321H, 432JF342R, and 958IO692T, all of which are produced by manufacturer AP1, as indicated by the provider identifier AP1 that is commonly used in each of these compound identifiers.

It will be understood that a reseller may stock the same product from more than one provider. For example, the product associated with the product identifier “234NG321H” may be a battery. Two different providers may sell this product and a reseller may keep batteries from both of these providers in stock. A first of the two providers may be assigned a provider identifier of HHH, while a second of the two providers may be assigned a provider identifier of PPP. To ensure that the 234NG321H product is properly linked to the provider that supplied the product to the reseller, the server 105 appends the appropriate provider identifier to the 234NG321H product identifier. Thus, it may be that a reseller has ten batteries in stock that are defined by a compound identifier of 234NG321H-HHH and five batteries in stock that are defined by a compound identifier of 234NG321H-PPP. If needed, the provider that is specified by a provider identifier can be determined quickly and easily. Thus, the server 105 can immediately determine a provider associated with a product if it is defective or needs to be returned. These methods will be described in greater detail below.

In some embodiments, the product identifier and provider identifier are linked to one another with a non-standard character, referred to as a separator. A separator may include a “@” or any other symbol (or set of symbols), as desired. In some instances the product identifier and provider identifier are set in spaced apart relationship to one another, such as “958IO692T AP1”.

According to some embodiments, the compound identifier may include a tertiary identifier, which is appended to a compound identifier that includes a product identifier and provider identifier. For example, “958IO692T-AP1-032014” includes a tertiary identifier of “032104” which may refer to an in-service date for the product. The terms “in-service date” may be understood to include any of: (a) a date the product was manufactured; (b) a date the product was shipped by the manufacturer; (c) a date that the product was received by the reseller; (d) a date that the reseller sold the product; (e) the date when the product was received by the customer; (f) a warranty initiation date; (g) a warranty expiration date, or any other date that would be known to one of ordinary skill in the art that references duties or obligations of the manufacturer, reseller, and/or customer.

Appending a tertiary identifier to a compound identifier may allow a reseller to quickly and easily identify important dates associated with the product. The format of the tertiary identifier may include any common date format.

While the tertiary identifier may include a reference to a date, the tertiary identifier may include a representation of any attribute of the product which the reseller or manufacturer would like to track. For example, the tertiary identifier may include a country identifier, lot number, shipping tracking number, price, or other information.

In addition to a tertiary identifier, the compound identifier may include additional identifiers, which may each represent a unique type of information about the product. Each additional identifier can be appended to the compound identifier successively. For example, “958IO692T-AP1-032014-CN-14.95” would specify a product 958IO692T, provider of AP1, a warranty start month of March 2014, a country of origin of China, and a price of $14.95 USD. One of ordinary skill in the art will appreciate that many permutations of additional identifiers may also likewise be utilized as long as the additional identifiers are appended to a base compound identifier that includes a product identifier and a provider identifier for a provider.

As mentioned above, in some instances the product identifier comprises segments. These segments are indicative of a unique attribute of a product. For example, 958IO692T may include segments of “958” that indicate that the product is for a touchscreen component, a segment “IO” that indicates generally that the product is an I/O device, “692” is a segment that indicates that the touchscreen has a resolution of at least (4096×4096 DPI), and a segment “T” that indicates that the touchscreen can be used in all “Apple” model cell phones.

In some instances, the server 105 can create the product identifier from known attributes of a product. In other instances, the product identifier is a random generation of characters that is unique for the product with which it is associated.

In accordance with the present disclosure, inventory managers for a reseller may use the server 105 to create compound identifiers for all products within their inventory. As products are received into inventory, the products are associated with a compound identifier. If the product is new and has never been held in inventory, the server 105 may query the database 160 for other similar products that have similar attributes as the new product. Alternatively, the server 105 may generate a random product identifier for the product. If the new product is associated with a provider that has a provider identifier assigned thereto, the server 105 may append the provider identifier to the generated product identifier. This compound identifier is linked to the product and stored as a record in the database 160.

Additionally, each compound identifier may be associated with metadata about the product. For example, a compound identifier for a touchscreen device may include metadata about the types of devices with which the product is used, the type of product, the size of the product, or other various types of information. For example, a touchscreen device may include metadata that specifies dimensions, resolution, device compatibility, power consumption, and so forth.

Each record for a product within the database 160 may therefore include not only the compound identifier, but also attributes of the product that allow the product to be queried. The attributes of the product may be stored in a conventional table format, or, as mentioned above, stored as metadata that is associated with the compound identifier.

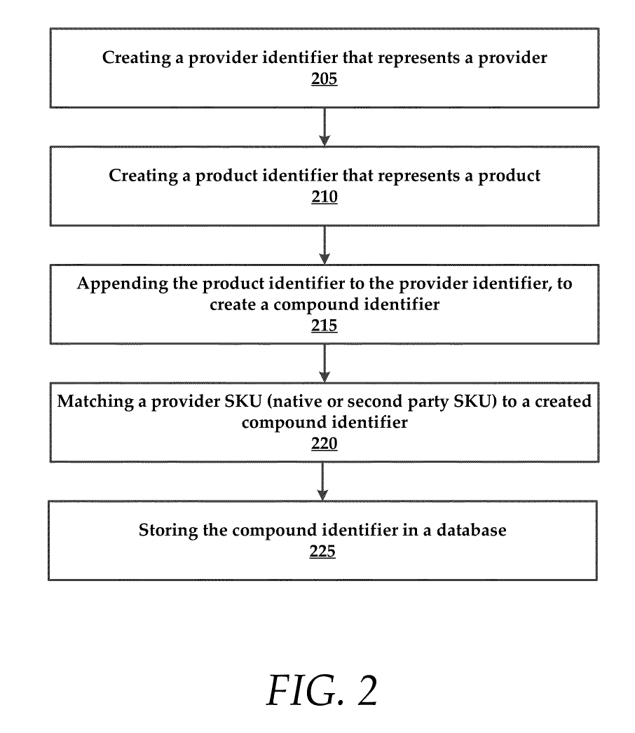

FIG. 2 is a flowchart of a method for creating and using a compound identifier. The method may include creating a compound identifier. This process may include creating 205 a provider identifier, which as mentioned above as being a portion of a compound identifier. The provider identifier identifies the provider of a particular product or plurality of products.

Once the provider identifier has been created for the provider the method includes creating 210 a product identifier. This product identifier may include metadata that is representative of attributes or parameters of a product. The metadata may include, but is not limited to date, size, color, type, dimensions, resolution, price, device compatibility, manufacturer, and so forth, as well as any combination of the aforementioned metadata types.

The method may also include appending 215 the provider identifier to the product identifier, to create a compound identifier.

By way of example, a product identifier may be assigned to a provider such as AX1. A provider identifier may be appended to the product identifier to identify a product type such as a touchscreen display, which has a product identifier of 345312243. The compound identifier would be AX1-345312243. Other product identifiers may be appended to the provider identifier to create compound identifiers for a plurality of other types of products which are provided by the provider AX1.

In some embodiments, the method may include matching 220 a provider SKU (native or second party SKU) to a created compound identifier such that the provider can associate a compound identifier for a product to a native SKU used by the provider to identify their products internally. For example, the native SKU may include 456-FJHTS, while the compound identifier used by the server 105 would include AX1-345312243.

In some instances, the server 105 may be configured to receive a provider SKU and attributes of the product that is represented by the provider SKU. These attributes may include descriptive information about the product, which is defined by the provider. The server 105 can match the provider SKU to a compound identifier by comparing the product attributes of the provider SKU with the descriptive metadata of the product identifier. If the attributes of the provider SKU and the metadata of the product identifier match the server 105 may link the provider SKU and compound identifier in an index or file. The link is created because the provider SKU and compound identifier each represent the same product.

In another example, the second party can query a database to locate a product using descriptive terms associated with the product. If the server 105 locates a product identifier in response to the query the second party may be prompted to input their native SKU. This native SKU will be recorded in the database as being associated with the compound identifier created for the product.

The method may also include storing 225 the compound identifier in a database. This may also involve storing the compound identifier with the native SKU in a database.

As mentioned above, the server 105 may also be configured to receive a list of products with their native SKUs. Each product in the list is associated with metadata or attributes that describe the product associated with the native SKU. The server 105 may match these native SKUs and their attributes to compound identifiers in the database. Thus, the server 105 can automatically link native SKUs and compound identifiers. In greater detail, the server 105 receives an inventory list from a second party, such as one or more of the provider 110A-N. Rather than requiring manual creation of product records, the server 105 is configured to receive an inventory list comprising a plurality of products that each comprises a second party SKU. The inventory list may include a description for each of the products; the description may include attributes that can be compared to the attributes of products stored in the database 160. The server 105 can compare the attributes of products on the list to product descriptions in the database 160 and determine how the products should be categorized. Further, the server 105, for each product in the inventory list, may generate a compound identifier. Additionally, the server 105 may associate the second party SKU with the compound identifier created for the product. As with manually defined products, the server 105 may store records for these new products in the database 160.

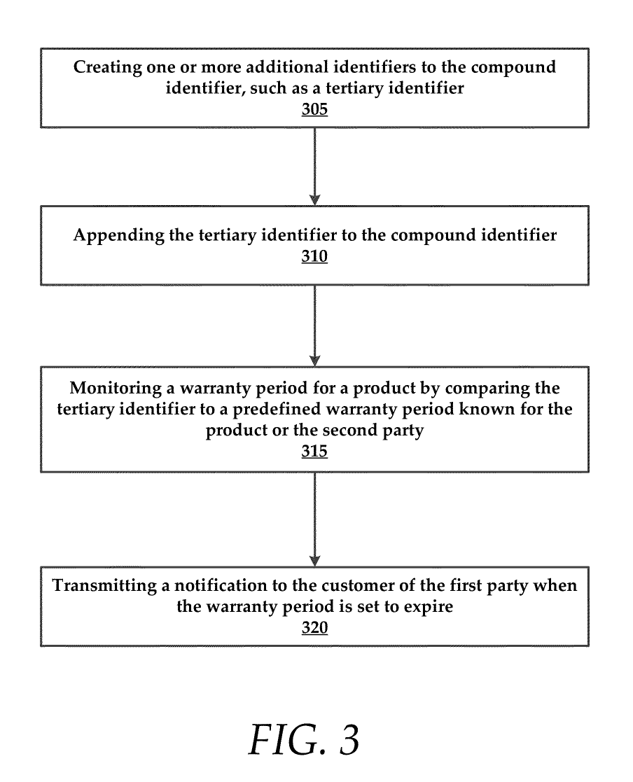

FIG. 3 is a flowchart of a method for creating an extended compound identifier. In some embodiments, the method may include creating 305 one or more additional identifiers to the compound identifier, such as a tertiary identifier. This tertiary identifier may represent various forms of metadata that are tied to a compound identifier and represent, for example, reporting, metrics, triggers for notification, search queries, and other similar metadata that would be known to one of ordinary skill in the art.

The method further includes appending 310 this tertiary identifier to the compound identifier. Again, additional identifiers (e.g., types of metadata) can also be appended to the compound identifier. For example, a tertiary, fourth, fifth, or additional identifier may be appended to the compound identifier. Each of these additional identifiers may be representative of a different type of metadata.

In an example use case a tertiary identifier may specify a warranty period for a product associated with a compound identifier. The warranty period may be appended to the compound identifier as a tertiary identifier. For example, AX1-345312243-6MO, where 6MO is a tertiary identifier that represents a warranty period of six months.

Thus, the method may include monitoring 315 a warranty period for a product by comparing the tertiary identifier to a predefined warranty period known for the product or the second party.

Next, the method may include transmitting 320 a notification to the customer of the first party when the warranty period is set to expire. This may also include sending a notification to the first party as well.

While this example contemplates the use of a tertiary identifier to monitor a warranty period, it is appreciated that the tertiary identifier can be used for other purposes, which depend upon the information represented by the tertiary identifier.

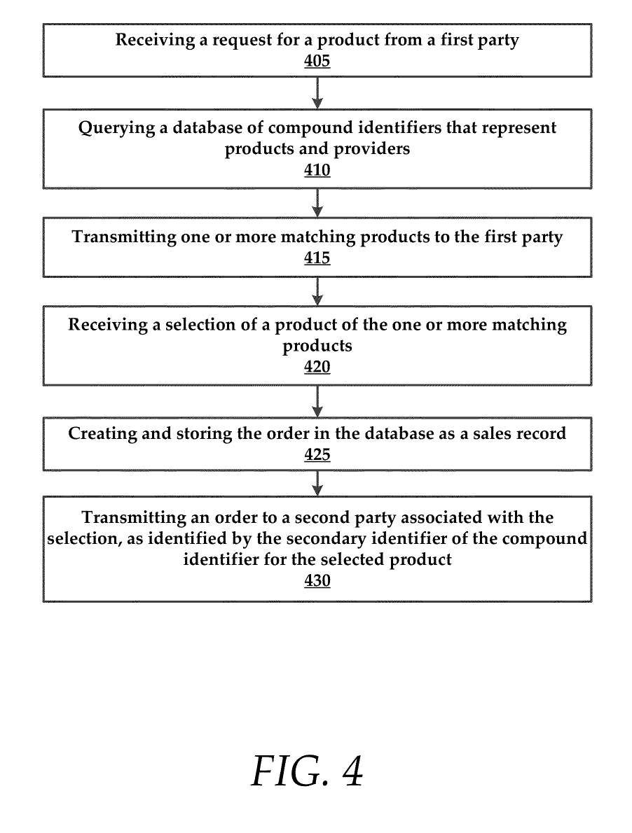

FIG. 4 is a flowchart of a method for inventory and supply chain control, and more specifically to a method for placing an order, which involves the use of a compound identifier. Once the database has been populated with products, and a customer has requested a product or service from a reseller, such as reseller 115A, the reseller 115A may utilize the server 105 to locate a product or products that are necessary for the customer device. The server 105 provides a graphical user interface (GUI) that allows a reseller to search for of select products in inventory. For example, the reseller may need to obtain a new battery for a particular type of cell phone. The reseller selects the attributes of the cell phone such as a device manufacturer or device model number and various attributes for that particular model. Other criteria can be selected that aid the server 105 in narrowing down the large number of available products for any given device.

In some embodiments, this process is referred to in the method as the server 105 receiving 405 a request for a product from a first party, which in this example is reseller system 115A. The request includes search parameters that correspond to product attributes/metadata described above, which are part of the records of products stored in the database 160.

Next, the method includes the server 105 querying 410 a database of compound identifiers that represent products and associated providers. Again, a compound identifier comprises a product identifier that identifies a product and a provider identifier that is appended to the product identifier. As described above the provider identifier identifies a second party that manufactures, distributes, or sells the product.

After the server 105 locates products that match the specifications of the query, the method includes the server 105 transmitting 415 one or more matching products to the first party. For example, the server 105 may locate three separate compound identifiers that are associated with a product attributes/metadata specified in the query. The attributes may include “battery”, “at least eight hours of talk time”, and “lithium ion”. The three compound identifiers are then transmitted to the reseller.

These products may include products that are stored at the reseller's physical location, a warehouse, or even the manufacturer.

The reseller then chooses one of the three products for the customer device, which causes the server 105 to receive a selection of a product of the one or more matching products. This selection is referred to as an “order”. The method thus includes the server 105 receiving 420 a selection of a product of the one or more matching products.

To track purchases, the method may include the server 105 creating and storing 425 the order in the database 160 as a sales record. The sales record may include a sales date, a product description, price information, and the compound identifier. Because sales records indicate the compound identifier of products in a sale event, the server 105 can track and count the amount of product sold by any reseller in terms of provider. Namely, the server 105 can count the number of sales records that reference a second party's provider identifier.

If the product is being ordered directly from a provider, the method may include the server 105 transmitting 430 an order to a second party associated with the selection, as identified by the provider identifier of the compound identifier for the selected product. In some instances the product may need to be ordered if it is not in stock with the reseller network. The provider can then fulfill the order as specified.

As mentioned above, an inventory manager may input products into the database 160 in a format that is desired so as to allow products to be searched efficiently.

In some instances, the method may include optional steps such as tracking an order for the selected product. This may include the system monitoring orders for selected products to ensure that products are delivered on time as well as placed into inventory in an expeditious manner.

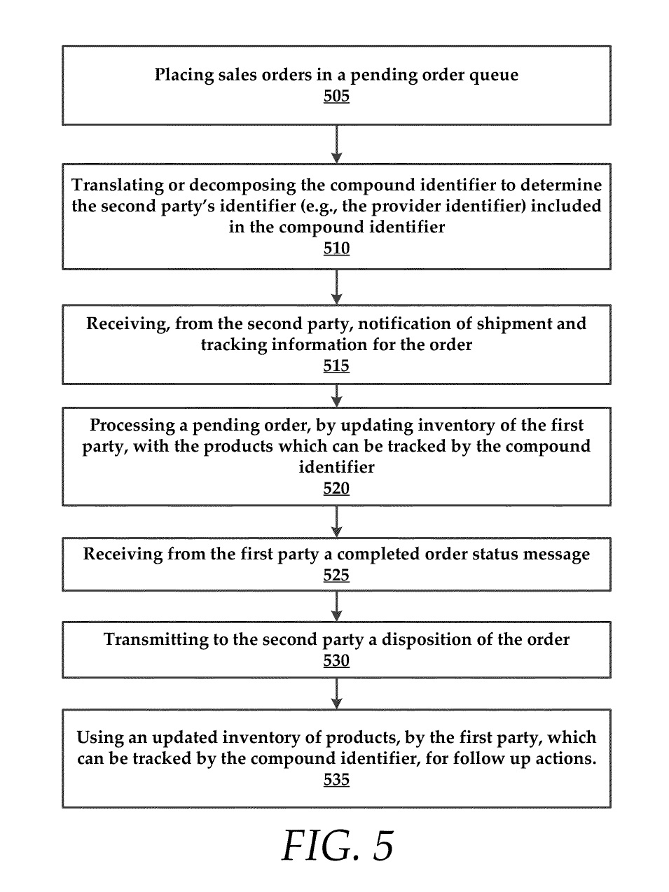

FIG. 5 is a method for order tracking, which involves the use of a compound identifier. This method may include placing 505 sales orders in a pending order queue. The second party receives an order based upon items identified from one or more compound identifiers by the system translating or decomposing 510 the compound identifier to determine the second party's identifier (e.g., the provider identifier) included in the compound identifier. The method also includes receiving 515, from the second party, notification of shipment and tracking information for the order. This includes the system receiving the native SKU for the product that was requested using the compound identifier and correlating the native SKU with the compound identifier to create the appropriate shipment and tracking information. The server provides the shipment and tracking information to the first party. In some instances the native SKU may not be provided to the first party, but only the compound identifier.

Translating or decomposing the compound identifier may include first identifying a compound identifier from a sales order or other similar medium that may bear a compound identifier. The translating or decomposing may include separating the product and provider identifiers from one another. In other embodiments, the product and provider identifiers are not split apart, but the provider identifier can be determined from examining the compound identifier and locating a three digit identifier appended to a product identifier.

The method may also include processing 520 the order into inventory by the first party. For example, this may include executing a receive order function by the first party. The method includes receiving 525 from the first party a completed order status message, as well as a step of transmitting 530 to the second party a disposition of the order.

In some embodiments, the method may include using 535 an updated inventory of products, by the first party, which can be tracked by the compound identifier, for follow up actions. The compound identifier can be used for various purposes (referred to as follow up actions), such as reporting, return materials authorized (RMA), and/or salvage. The compound identifier ensures that the proper second party is identified in a follow up action.

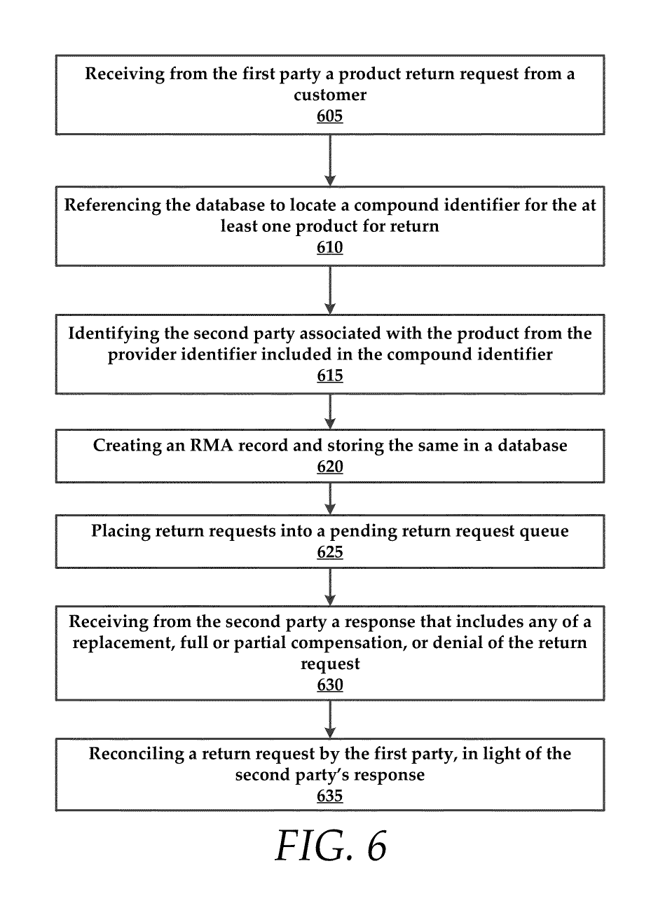

FIG. 6 is a flowchart of a return materials authorized process. The method includes receiving 605 from the first party a product return request from a customer. For example, a customer may return an accessory for their customer device 120. A reseller may create a product return request by entering information that is indicative of the customer device 120. The method includes the server 105 identifying a sales record that references the at least one product for return. For example the reseller may input the customer's device information or customer information and can review sales records for the customer that include products that have been sold to the customer. The reseller selects the product that the customer desires to return.

Once the reseller has selected the product for return, the method comprises the server 105 referencing 610 the database 160 to locate a compound identifier for the at least one product for return. Next, the method includes the server 105 automatically identifying 615 the second party associated with the product from the provider identifier included in the compound identifier.

The method may further include creating 620 an RMA record and storing the same in a database. The method may include placing 625 return requests into a pending return request queue. The second party may receive an order based on the products identified by compound identifiers. Again, the second party or parties can be determined from examining the compound identifiers.

In accordance with the present disclosure, the method may include receiving 630 from the second party a response that includes any of a replacement, full or partial compensation, or denial of the return request. The system may notify the first party by transmitting the response to the first party.

The method may also include reconciling 635 a return request by the first party, in light of the second party's response. The step of reconciling may include an identification of return request as complete.

Although not shown, the method may include tracking and storing the return requests. These return requests can be used as the basis for reporting or metrics that identify features such as a highest number of returned products. The server 105 can be used to query the database for return requests and determine the compound identifiers of each return request. The server 105 can sum or aggregate counts of the compound identifiers and create reports that describe how many return requests were processed for each provider. For example, there may be ten return requests that include compound identifiers for products, which include the provider identifier of AX1. Thus, the server 105 determines that the provider associated with the provider identifier of AX1 has had ten returns.

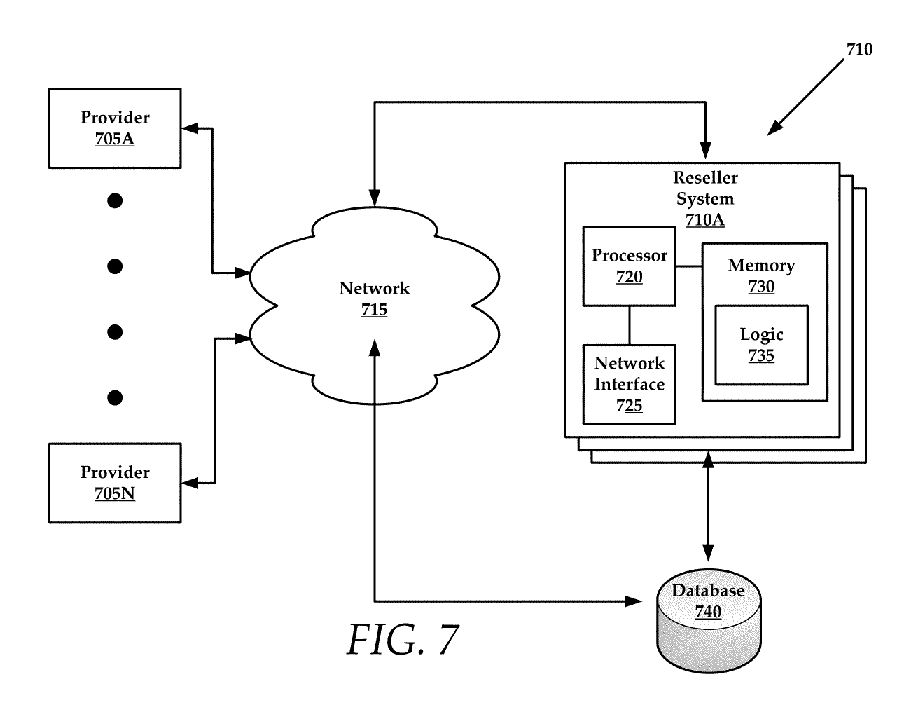

FIG. 7 illustrates an exemplary architecture for practicing aspects of the present technology. The architecture of FIG. 7 is similar to the architecture of FIG. 1 with the exception that the functionalities and features of the server 105 in FIG. 1 are embodied in the reseller system 710A, or in each of a plurality of reseller systems 710.

Generally the reseller systems 710A are each configured to communicate with external systems, such as provider systems 710A-N, as well as database 740. It will be understood that the provider and reseller systems that are described in various embodiments herein are merely an example description of roles that can be attributed to entities that can be configured to use the inventory and supply chain features provided by the reseller system 710A. The methods and system described herein can likewise be applied to other industries having other typical participating parties that utilize an inventory control systems.

The reseller system 710A may communicatively couple with both the providers 705A-N and database 740 via a public or private network, such as network 715. Example networks that can be utilized are described in greater detail above with reference to FIG. 1.

The reseller system 710A generally comprises a processor 720, a network interface 725, and a memory 730. According to some embodiments, the memory 730 comprises logic (e.g., instructions or applications) 735 that can be executed by the processor 720 to perform various methods, such as a method for inventory and supply chain management.

It will be understood that the reseller network 710 may include many reseller systems such as reseller system 710A that are distributed. This distribution may include a geographical distribution or a distribution within a single location of a plurality of systems. Each of these systems may couple with the provider systems 705A-N.

FIG. 8 illustrates an exemplary computing device 1 that may be used to implement an embodiment of the present systems and methods. The system 1 of FIG. 8 may be implemented in the contexts of the likes of the server 105 described herein. The computing device 1 of FIG. 8 includes a processor 10 and main memory 20. Main memory 20 stores, in part, instructions and data for execution by processor 10. Main memory 20 may store the executable code when in operation. The system 1 of FIG. 8 further includes a mass storage device 30, portable storage device 40, output devices 50, user input devices 60, a display system 70, and peripherals 80.

The components shown in FIG. 8 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 8. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys, or a scanner for reading bar codes. Additionally, the system 1 as shown in FIG. 8 includes output devices 50. Suitable output devices include speakers, label and receipt printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 8 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, PHP, MySQL, HTML, Java Script, CSS, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

1. A method of inventory and supply chain management executed by an inventory management system that comprises a processor and a memory for storing logic, the processor executing the logic to perform the method, comprising:
receiving a request for a product from a first party that comprises a description of the product;
querying, using the description, a database of compound identifiers that each represent a relationship between a product and a provider, a first product comprising a provider identifier identifying a first provider party that manufactures, distributes, or sells the product, a second product, identical to the first product, comprising a second provider identifier identifying a second provider party that manufactures, distributes, or sells the same product, wherein the first product and the second product are identical to one another and share an identical product identifier therebetween, but the first provider party and the second provider party are different entities, the first provider identifier being appended to the identical product identifier to create a first compound identifier, the second provider identifier being appended to the identical product identifier to create a second compound identifier, wherein the first provider identifier for the first provider party and the second provider identifier for the second provider party each comprise a unique character set used to represent only a respective provider;
transmitting information indicative of at least one of the first and second product to the first party;
receiving a selection of the first or second product from the first party; and
storing a sales order for the selection in a database, the sales order comprising the compound identifier for the selection.

2. The method according to claim 1, further comprising:
tracking an order for the selection, and
reconciling a return merchandize authorization for the selection (RMA) by:
obtaining the sales order for the selection;
identifying whether the first provider party or the second provider party are associated with the selection by consulting a mapping that links provider parties to compound identifiers, each provider party being mapped to one or more compound identifiers by way of a provider identifier included in the compound identifier associated with the selection; and
transmitting the RMA to the identified provider party.

3. The method according to claim 1, further comprising transmitting an order to the provider party, either the first or the second, associated with the selection, as identified by the provider identifier of the compound identifier for the selected product.

4. The method according to claim 1, further comprising creating a first compound identifier and a second compound identifier by assigning:
a set of alphanumeric characters as the product identifier for the first product;
a set of alphanumeric characters as the provider identifier for the first provider party;
joining the product identifier and the provider identifier together with a separator disposed therebetween, to form the first compound identifier;
a set of alphanumeric characters as the product identifier for the second product;
a set of alphanumeric characters as the provider identifier for the second provider party; and
joining the product identifier and the provider identifier together with a separator disposed therebetween, to form the second compound identifier, wherein the product identifier for the first product and the product identifier for the second product are identical to one another and the provider identifier for the first provider party and the provider identifier for the second provider party are discrete relative to one another.

5. The method according to claim 1, further comprising storing the first and second compound identifiers in a database.

6. The method according to claim 1, further comprising:
receiving an inventory list from either of the first and second parties, the inventory list comprising a plurality of products that each comprise a provider party SKU, the products being defined by metadata; and
for each product in the inventory list, associating the second party SKU with a compound identifier created for the product using the metadata.

7. The method according to claim 1, wherein the first compound identifier further comprises a tertiary identifier that includes a date, the tertiary identifier being appended to the product identifier and the provider identifier.

8. The method according to claim 7, wherein the date includes an in-service date or a warranty period.

9. The method according to claim 8, further comprising monitoring a warranty period for the first product by comparing the tertiary identifier to a predefined warranty period known for the first product or the first provider party; and transmitting a notification to a customer of the first party when the warranty period is set to expire.

10. The method according to claim 1, further comprising separating the product identifier into segments, wherein each of the segments is indicative of a unique attribute of a product.

11. The method according to claim 1, further comprising creating a sale record that includes the compound identifier for the selection; and storing the sale record in the database.

12. The method according to claim 11, further comprising:
receiving from the first party a product return request from a customer, the product return request identifying the product associated with the selection, for return;
identifying a sales record that references the product for return;
referencing the database to locate the compound identifier for the product for return;
and
automatically identifying a provider party associated with the product from a provider identifier included in the compound identifier.

13. The method according to claim 1, further comprising:
tracking return requests for products;
locating compound identifiers for the products;
and
counting provider identifiers for each of the compound identifiers of each of the products to create an aggregate return amount for each provider party identified by at least one of the provider identifiers.

14. The method according to claim 13, further comprising determining a provider party with a highest number of returned products.

15. A method of inventory and supply chain management executed by an inventory management system that comprises a processor and a memory for storing logic, the processor executing the logic to perform the method, comprising: maintaining a database of compound identifiers that represent products and providers, wherein a compound identifier comprises a product identifier that identifies a product and a provider identifier that is appended to the product identifier, the provider identifier identifying a party that manufactures, distributes, or sells the product.

16. The method according to claim 15, further comprising:
receiving a message from a reselling party that indicates that a product has been sold to a customer; and
storing a record of a sale in the database.

17. The method according to claim 16, further comprising tracking physical distribution of a plurality of a single product to a plurality of reselling parties, the reselling party being one of the plurality of reselling parties.

18. The method according to claim 17, wherein each of the plurality of reselling parties is associated with a unique physical location.

19. The method according to claim 18, further comprising identifying one or more physical locations at which the plurality of the single product are located by:
consulting a database for the physical distribution for the plurality of the single product;
identifying which of the plurality of the single product have been sold, if any;
and
displaying the unique physical locations for each of the plurality of the single product that remain in stock.

20. An inventory and supplier control system, comprising:
means for querying a database of compound identifiers that represent products and providers, a first product comprising a provider identifier identifying a first provider party that manufactures, distributes, or sells the product, a second product, identical to the first product, comprising a second provider identifier identifying a second provider party that manufactures, distributes, or sells the same product, wherein the first product and the second product are identical to one another and share an identical product identifier therebetween, but the first provider party and the second provider party are different entities, the first provider identifier being appended to the identical product identifier to create a first compound identifier, the second provider identifier being appended to the identical product identifier to create a second compound identifier, wherein the first provider identifier for the first provider party and the second provider identifier for the second provider party each comprise a unique character set used to represent only a respective provider;
receiving a selection of the first or second product from the first party;
and
means for transmitting an order to the first or second provider party associated with the selection, as identified by the provider identifier of the compound identifier for the selection.

21. The inventory and supplier control system according to claim 20, further comprising means for storing the order in a database.

22. The inventory and supplier control system according to claim 20, further comprising means for creating the first compound identifier by assigning:
a set of alphanumeric characters as the product identifier for the first product;
a set of alphanumeric characters as the provider identifier for the first provider party; and
joining the product identifier and the provider identifier together with a separator disposed therebetween, to form the first compound identifier.

23. A method, comprising:
generating a product identifier that represents a product;
generating a provider identifier that identifies a party that provides the product to a reseller, wherein the reseller is a party that conveys the product to a customer;
joining the product identifier with the provider identifier to create a compound identifier;
and
storing the compound identifier in a database.

24. The method according to claim 23, further comprising:
creating metadata for the compound identifier, the metadata comprising attributes for the product;
and
associating the metadata with the compound identifier.

25. The method according to claim 24, further comprising:
receiving a provider stock keeping unit (SKU) and product attributes for the product from the provider;
querying the database to determine a compound identifier that has metadata that matches the product attributes of the provider SKU;
and
linking the provider SKU and the compound identifier in an index or file.

26. A method of inventory and supply chain management executed by an inventory management system that comprises a processor and a memory for storing logic, the processor executing the logic to perform the method, comprising:
receiving a request for a product from a first party, wherein the request comprises a first compound identifier for the product, wherein the first compound identifier includes a product identifier that identifies the product and a provider identifier that identifies the party that manufactures, distributes, or sells the product;
decomposing the first compound identifier to obtain the provider identifier included therein by separating the first product identifier from the provider identifier;
transmitting the sales order to a second party using the provider identifier;
receiving from the second party, notification that the product has shipped by:
receiving a native stock keeping unit (SKU) for the product from the second party;
correlating the native SKU with the first compound identifier for the product to create shipping and tracking information;
transmitting the shipping and tracking information to the first party;
receiving the product from the second party; and
integrating the first compound identifier for the product into a database of compound identifiers that each represent a relationship between a product and a provider, wherein the product is a first product comprising a provider identifier identifying a first provider party that manufactures, distributes, or sells the product, a second product, identical to the first product, comprising a second provider identifier identifying a second provider party that manufactures, distributes, or sells the same product, wherein the first product and the second product are identical to one another and share a substantially identical product identifier therebetween, but the first provider party and the second provider party are different entities, the first provider identifier being appended to the product identifier to create the first compound identifier, the second provider identifier being appended to the product identifier to create a second compound identifier, wherein the first provider identifier for the first provider party and the second provider identifier for the second provider party each comprise a unique character set used to represent only a respective provider, wherein the second compound identifier is linked to a unique a native SKU.
